(19) United States
(12) Patent Application Publication
(10) Pub. No.: US 2024/0312442 A1
(43) Pub. Date: Sep. 19, 2024

(54) MODIFICATION OF MIDI INSTRUMENTS TRACKS

(71) Applicant: Lenovo (Singapore) Pte. Ltd., Singapore (SG)

(72) Inventors: Dane Hixon, Eden, UT (US); Matthew Fardig, Boonville, IN (US); Davidson Banner, Lindon, UT (US); Clint David Bicknell, Franklin, OH (US)

(21) Appl. No.: 18/184,387

(22) Filed: Mar. 15, 2023

(51) Int. Cl. G10H 1/00

(52) U.S. Cl. CPC G10H 1/0066; G10H 1/0008

(57) ABSTRACT

A system receives output from a machine learning algorithm. The machine learning algorithm was trained to learn a music characteristic of work of music. The system then receives a musical instrument digital interface (MIDI) track. The MIDI track includes a MIDI characteristic of the MIDI track. The system finally modifies the MIDI characteristic of the MIDI track as a function of the music characteristic of the work of music.

### TECHNICAL FIELD

Embodiments described herein generally relate to musical instrument digital interfaces (MIDI), and in an embodiment, but not by way of limitation, using machine learning to modify MIDI tracks.

### BACKGROUND

A musical instrument digital interface (MIDI) provides a standard that allows electronic or digital musical instruments to communicate with each other and with computers. For example, a MIDI-compatible sequencer can trigger beats produced by a drum sound module. A MIDI interface records messages and information about musical notes, not the specific sounds of the notes. Consequently, a MIDI recording can be changed to many other sounds, ranging from a synthesized or sampled guitar or flute to a full orchestra. A MIDI also enables other instrument parameters (volume, effects, etc.) to be controlled remotely.

Because a MIDI performance is a sequence of commands that create sound, MIDI recordings can be manipulated in ways that audio recordings cannot. It is possible to change the key, instrumentation, or tempo of a MIDI arrangement, and to reorder its individual sections, or even edit individual notes.

However, when writing music using MIDI, it can be difficult to make the recorded track sound like a real recording, especially if the digital instrument is not one that the person making the song knows how to play. Current attempts to try to address this problem include manually adjusting MIDI tracks. This attempt however is very labor intensive and fraught with errors. Some Digital Audio Workstation (DAW) software provide ways to “randomize” or “un-quantize” MIDI tracks to make it sound more human. However, this is a random process and includes no intelligence. Some plugins such as Superior Drummer 3 take a raw drum track and parse it into a MIDI track using professionally recorded samples. However, this also lacks any intelligence in connection with modifying a MIDI track. In general, these solutions are time consuming, and/or they do not provide an accurate representation or sound of how a real human playing the instrument would sound.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not limitation, in the figures of the accompanying drawings.

FIG. 1 is a high-level diagram of a process to modify a MIDI track using output from a machine learning algorithm.

FIGS. 2A and 2B are a detailed diagram of a process to modify a MIDI track using output from a machine learning algorithm.

FIG. 3 is a block diagram of a computer architecture upon which one or more of the embodiments disclosed herein can execute.

### DETAILED DESCRIPTION

An embodiment uses Deepfake audio technology combined with musical instrument digital interface (MIDI) programming to take an existing MIDI track and combine it with the nuances, characteristics and/or styles of musicians that have been learned from machine learning algorithms. This embodiment involves three steps. First, the styles of a musician or musicians are used to train a machine learning algorithm by providing audio data from the musician or musicians to the machine learning algorithm. Second, a MIDI track is scanned to identify in the MIDI track meta data that are related to such nuances, characteristics and/or styles of the musician or musicians. For example, a MIDI track can be scanned to learn the notes, chord progressions, key changes, and rhythm that the producer is attempting to make. Third, the metadata in the MIDI track are modified or adjusted to match or mimic the style of the musician or musicians as was learned by the machine learning algorithm.

The data provided from the machine learning algorithm are meshed with the existing MIDI data to create a track of music as if that musician had played it. This meshing could involve a modification of an existing MIDI track and/or adding new metadata to the existing MIDI track. This step involves an analysis step to calculate adjustment to the existing MIDI track, as well as the actual adjustment itself. Some aspects that could be learned of the musician or musicians by the machine learning algorithm include, but are not limited to, timing and rhythm, attack and/or sustain patterns, voicing techniques and transition patterns. This learning by the machine learning algorithm could be accomplished by examining raw tracks of the musician or musicians, and/or by intelligently listening for specific instruments in the provided audio data.

Some use cases include, but are not limited to, producing music where a producer wants an instrument to have a certain feel of a particular artist. Or being able to randomize instruments upon playback to get a more “live” feel. Or being able to replace artists in a particular song upon playback. For example, playing Prince's Purple Rain, but using John Bonham on the drums.

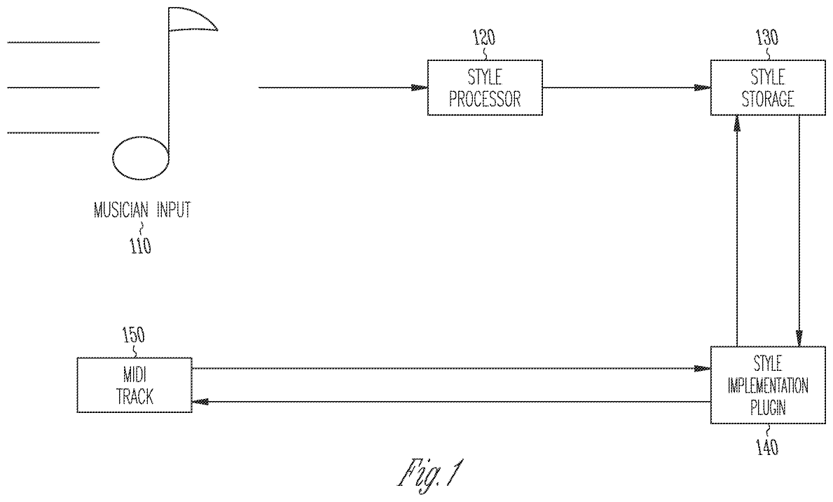

FIG. 1 is a high-level diagram of a process to modify a MIDI track using output from a machine learning algorithm. As referred to above, music input from a musician or musicians is received at 110. This musical input is actual audio data played and/or recorded by the musician or musicians. This music input is used to train a machine learning algorithm in the style of the musician or musicians at 120, which is indicated as a style (computer) processor in FIG. 1. The data learned from the style processor are stored in style storage 130. A style implementation plugin 140 is used to couple to the MIDI interface. The style implementation plugin 140 provides the learned data or style of the musical input to the MIDI track 150, wherein the metadata of the MIDI track 150 are modified using the learned data or style of the musical input.

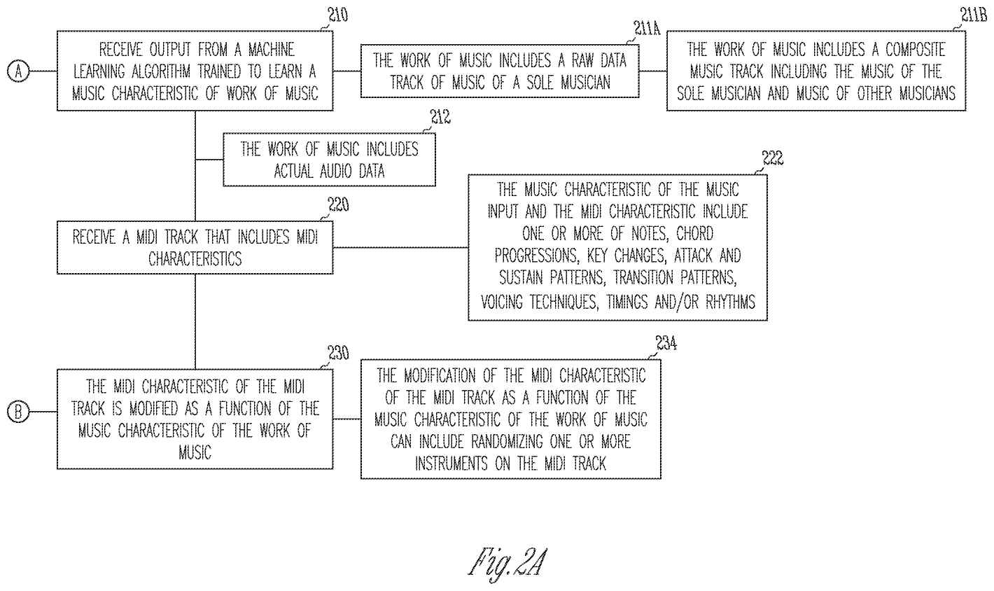

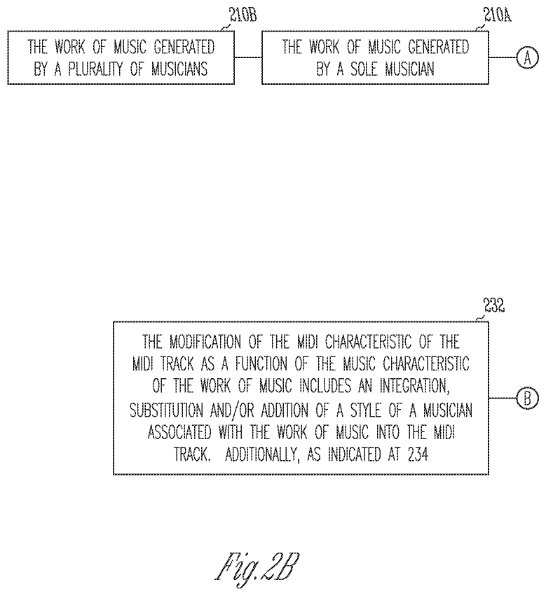

FIGS. 2A and 2B are a block diagram illustrating example embodiments of operations and features of a system and method for modifying a MIDI track using output from a trained machine learning algorithm. FIGS. 2A and 2B include a number of process and feature blocks 210-234. Though arranged substantially serially in the example of FIGS. 2A and 2B, other examples may reorder the blocks, omit one or more blocks, and/or execute two or more blocks in parallel using multiple processors or a single processor organized as two or more virtual machines or sub-processors.

Referring now specifically to FIGS. 2A and 2B, at 210, output from a machine learning algorithm is received into a computer processor. In an embodiment, this computer processor is the style implementation plugin 140 in FIG. 1. The machine learning algorithm output was trained to learn a music characteristic of works of music, such as the music input 110 as learned by the style processor 120 in FIG. 1. The works of music can be generated by a sole musician (210A), or the works of music can be generated by a plurality of musicians (210B). Similarly, the works of music can include a raw data track of music of a sole musician (211A), or the works of music can include a composite music track including the music of the sole musician and music of other musicians (211B). As noted at 212, the works of music include actual audio data (as contrasted with MIDI metadata).

At 220, a MIDI track is received into the computer processor or style implementation plugin. The MIDI track includes one or more MIDI characteristics. As noted at 222, the music characteristic of the music input and the MIDI characteristic can include one or more of notes, chord progressions, key changes, attack and sustain patterns, transition patterns, voicing techniques, timings and/or rhythms.

Then, at 230, the MIDI characteristics of the MIDI track are modified as a function of the music characteristics of the works of music. As noted above and as specifically referred to at 232, the modification of the MIDI characteristic of the MIDI track as a function of the music characteristic of the works of music can include an integration, substitution and/or addition of a style of a musician associated with the works of music into the MIDI track. Additionally, as indicated at 234, the modification of the MIDI characteristic of the MIDI track as a function of the music characteristic of the works of music can include randomizing one or more instruments on the MIDI track.

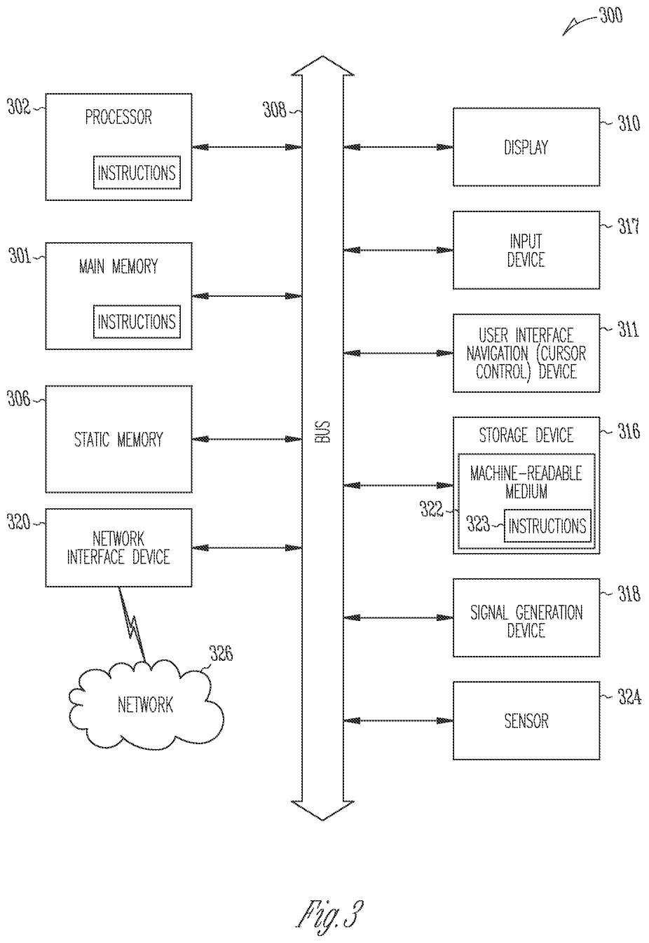

FIG. 3 is a block diagram illustrating a computing and communications platform 300 in the example form of a general-purpose machine on which some or all the operations of FIGS. 1, 2A and 2B may be carried out according to various embodiments. In certain embodiments, programming of the computing platform 300 according to one or more particular algorithms produces a special-purpose machine upon execution of that programming. In a networked deployment, the computing platform 300 may operate in the capacity of either a server or a client machine in server-client network environments, or it may act as a peer machine in peer-to-peer (or distributed) network environments.

Example computing platform 300 includes at least one processor 302 (e.g., a central processing unit (CPU), a graphics processing unit (GPU) or both, processor cores, compute nodes, etc.), a main memory 301 and a static memory 306, which communicate with each other via a link 308 (e.g., bus). The computing platform 300 may further include a video display unit 310, input devices 317 (e.g., a keyboard, camera, microphone), and a user interface (UI) navigation device 311 (e.g., mouse, touchscreen). The computing platform 300 may additionally include a storage device 316 (e.g., a drive unit), a signal generation device 318 (e.g., a speaker), a sensor 324, and a network interface device 320 coupled to a network 326.

The storage device 316 includes a non-transitory machine-readable medium 322 on which is stored one or more sets of data structures and instructions 323 (e.g., software) embodying or utilized by any one or more of the methodologies or functions described herein. The instructions 323 may also reside, completely or at least partially, within the main memory 301, static memory 306, and/or within the processor 302 during execution thereof by the computing platform 300, with the main memory 301, static memory 306, and the processor 302 also constituting machine-readable media.

While the machine-readable medium 322 is illustrated in an example embodiment to be a single medium, the term “machine-readable medium” may include a single medium or multiple media (e.g., a centralized or distributed database, and/or associated caches and servers) that store the one or more instructions 323. The term “machine-readable medium” shall also be taken to include any tangible medium that is capable of storing, encoding or carrying instructions for execution by the machine and that cause the machine to perform any one or more of the methodologies of the present disclosure or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks.

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, also contemplated are examples that include the elements shown or described. Moreover, also contemplated are examples using any combination or permutation of those elements shown or described (or one or more aspects thereof), either with respect to a particular example (or one or more aspects thereof), or with respect to other examples (or one or more aspects thereof) shown or described herein.

Publications, patents, and patent documents referred to in this document are incorporated by reference herein in their entirety, as though individually incorporated by reference. In the event of inconsistent usages between this document and those documents so incorporated by reference, the usage in the incorporated reference(s) are supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to suggest a numerical order for their objects.

The above description is intended to be illustrative, and not restrictive. For example, the above-described examples (or one or more aspects thereof) may be used in combination with others. Other embodiments may be used, such as by one of ordinary skill in the art upon reviewing the above description. The Abstract is to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. However, the claims may not set forth every feature disclosed herein as embodiments may feature a subset of said features. Further, embodiments may include fewer features than those disclosed in a particular example. Thus, the following claims are hereby incorporated into the Detailed Description, with a claim standing on its own as a separate embodiment. The scope of the embodiments disclosed herein is to be determined with reference to the appended claims, along with the full scope of equivalents to which such claims are entitled.

### EXAMPLES

Example No. 1 is a process to modify a musical instrument digital instrument (MIDI) track process comprising receiving into a computer processor output from a machine learning algorithm, the machine learning algorithm trained to learn a music characteristic of work of music; receiving into the computer processor a musical instrument digital interface (MIDI) track, the MIDI track comprising a MIDI characteristic of the MIDI track; and modifying the MIDI characteristic of the MIDI track as a function of the music characteristic of the work of music.

Example No. 2 includes all the features of Example No. 1 and optionally includes a process wherein the modifying the MIDI characteristic of the MIDI track as a function of the music characteristic of the work of music comprises integrating or substituting a style of a musician associated with the work of music into the MIDI track.

Example No. 3 includes all the features of Example Nos. 1-2 and optionally includes a process wherein the modifying the MIDI characteristic of the MIDI track as a function of the music characteristic of the work of music comprises randomizing one or more instruments on the MIDI track.

Example No. 4 includes all the features of Example Nos. 1-3 and optionally includes a process wherein the work of music is generated by a sole musician.

Example No. 5 includes all the features of Example Nos. 1-4 and optionally includes a process wherein the work of music is generated by a plurality of musicians.

Example No. 6 includes all the features of Example Nos. 1-5 and optionally includes a process wherein the work of music comprises a raw data track of music of a sole musician, or the work of music comprises a composite music track including the music of the sole musician and music of other musicians.

Example No. 7 includes all the features of Example Nos. 1-6 and optionally includes a process wherein the music characteristic and the MIDI characteristic comprise one or more of notes, chord progressions, key changes, attack and sustain patterns, transition patterns, voicing techniques, timings and rhythms.

Example No. 8 includes all the features of Example Nos. 1-7 and optionally includes a process wherein the music data comprise audio music data.

Example No. 9 is a machine-readable medium comprising instructions that when executed by a computer processor executes a process comprising receiving into the computer processor output from a machine learning algorithm, the machine learning algorithm trained to learn a music characteristic of work of music; receiving into the computer processor a musical instrument digital interface (MIDI) track, the MIDI track comprising a MIDI characteristic of the MIDI track; and modifying the MIDI characteristic of the MIDI track as a function of the music characteristic of the work of music.

Example No. 10 includes all the features of Example No. 9 and optionally includes a machine-readable medium wherein the modifying the MIDI characteristic of the MIDI track as a function of the music characteristic of the work of music comprises integrating or substituting a style of a musician associated with the work of music into the MIDI track.

Example No. 11 includes all the features of Example Nos. 9-10 and optionally includes a machine-readable medium wherein the modifying the MIDI characteristic of the MIDI track as a function of the music characteristic of the work of music comprises randomizing one or more instruments on the MIDI track.

Example No. 12 includes all the features of Example Nos. 9-11 and optionally includes a machine-readable medium wherein the work of music is generated by a sole musician.

Example No. 13 includes all the features of Example Nos. 9-12 and optionally includes a machine-readable medium wherein the work of music is generated by a plurality of musicians.

Example No. 14 includes all the features of Example Nos. 9-13 and optionally includes a machine-readable medium wherein the work of music comprises a raw data track of music of a sole musician, or the work of music comprises a composite music track including the music of the sole musician and music of other musicians.

Example No. 15 includes all the features of Example Nos. 9-14 and optionally includes a machine-readable medium wherein the music characteristic and the MIDI characteristic comprise one or more of notes, chord progressions, key changes, attack and sustain patterns, transition patterns, voicing techniques, timings and rhythms.

Example No. 16 includes all the features of Example Nos. 9-15 and optionally includes a machine-readable medium wherein the music data comprise audio music data.

Example No. 17 is a system including a computer processor; and a computer memory coupled to the computer processor wherein the computer processor and computer memory are operable for receiving into the computer processor output from a machine learning algorithm, the machine learning algorithm trained to learn a music characteristic of work of music; receiving into the computer processor a musical instrument digital interface (MIDI) track, the MIDI track comprising a MIDI characteristic of the MIDI track; and modifying the MIDI characteristic of the MIDI track as a function of the music characteristic of the work of music.

Example No. 18 includes all the features of Example No. 17 and optionally includes a system wherein the modifying the MIDI characteristic of the MIDI track as a function of the music characteristic of the work of music comprises integrating or substituting a style of a musician associated with the work of music into the MIDI track.

Example No. 19 includes all the features of Example Nos. 17-18 and optionally includes a system wherein the modifying the MIDI characteristic of the MIDI track as a function of the music characteristic of the work of music comprises randomizing one or more instruments on the MIDI track.

Example No. 20 includes all the features of Example Nos. 17-19 and optionally includes a system wherein the music characteristic and the MIDI characteristic comprise one or more of notes, chord progressions, key changes, attack and sustain patterns, transition patterns, voicing techniques, timings and rhythms.

1. A process comprising:
receiving into a computer processor output from a machine learning algorithm, the machine learning algorithm trained to learn a music characteristic of work of music;
receiving into the computer processor a musical instrument digital interface (MIDI) track, the MIDI track comprising a MIDI characteristic of the MIDI track; and
modifying the MIDI characteristic of the MIDI track as a function of the music characteristic of the work of music.

2. The process of claim 1, wherein the modifying the MIDI characteristic of the MIDI track as a function of the music characteristic of the work of music comprises integrating or substituting a style of a musician associated with the work of music into the MIDI track.

3. The process of claim 1, wherein the modifying the MIDI characteristic of the MIDI track as a function of the music characteristic of the work of music comprises randomizing one or more instruments on the MIDI track.

4. The process of claim 1, wherein the work of music is generated by a sole musician.

5. The process of claim 1, wherein the work of music is generated by a plurality of musicians.

6. The process of claim 1, wherein the work of music comprises a raw data track of music of a sole musician, or the work of music comprises a composite music track including the music of the sole musician and music of other musicians.

7. The process of claim 1, wherein the music characteristic and the MIDI characteristic comprise one or more of notes, chord progressions, key changes, attack and sustain patterns, transition patterns, voicing techniques, timings and rhythms.

8. The process of claim 1, wherein the music data comprise audio music data.

9. A non-transitory machine-readable medium comprising instructions that when executed by a computer processor executes a process comprising:
receiving into the computer processor output from a machine learning algorithm, the machine learning algorithm trained to learn a music characteristic of work of music;
receiving into the computer processor a musical instrument digital interface (MIDI) track, the MIDI track comprising a MIDI characteristic of the MIDI track; and
modifying the MIDI characteristic of the MIDI track as a function of the music characteristic of the work of music.

10. The non-transitory machine-readable medium of claim 9, wherein the modifying the MIDI characteristic of the MIDI track as a function of the music characteristic of the work of music comprises integrating or substituting a style of a musician associated with the work of music into the MIDI track.

11. The non-transitory machine-readable medium of claim 9, wherein the modifying the MIDI characteristic of the MIDI track as a function of the music characteristic of the work of music comprises randomizing one or more instruments on the MIDI track.

12. The non-transitory machine-readable medium of claim 9, wherein the work of music is generated by a sole musician.

13. The non-transitory machine-readable medium of claim 9, wherein the work of music is generated by a plurality of musicians.

14. The non-transitory machine-readable medium of claim 9, wherein the work of music comprises a raw data track of music of a sole musician, or the work of music comprises a composite music track including the music of the sole musician and music of other musicians.

15. The non-transitory machine-readable medium of claim 9, wherein the music characteristic and the MIDI characteristic comprise one or more of notes, chord progressions, key changes, attack and sustain patterns, transition patterns, voicing techniques, timings and rhythms.

16. The non-transitory machine-readable medium of claim 9, wherein the music data comprise audio music data.

17. A system comprising:
a computer processor; and
a computer memory coupled to the computer processor:
wherein the computer processor and computer memory are operable for:
receiving into the computer processor output from a machine learning algorithm, the machine learning algorithm trained to learn a music characteristic of work of music;
receiving into the computer processor a musical instrument digital interface (MIDI) track, the MIDI track comprising a MIDI characteristic of the MIDI track; and
modifying the MIDI characteristic of the MIDI track as a function of the music characteristic of the work of music.

18. The system of claim 17, wherein the modifying the MIDI characteristic of the MIDI track as a function of the music characteristic of the work of music comprises integrating or substituting a style of a musician associated with the work of music into the MIDI track.

19. The system of claim 17, wherein the modifying the MIDI characteristic of the MIDI track as a function of the music characteristic of the work of music comprises randomizing one or more instruments on the MIDI track.

20. The system of claim 17, wherein the music characteristic and the MIDI characteristic comprise one or more of notes, chord progressions, key changes, attack and sustain patterns, transition patterns, voicing techniques, timings and rhythms.
